(19) United States
(12) Patent Application Publication
(10) Pub. No.: US 2002/0157024 A1
(43) Pub. Date: Oct. 24, 2002

(54) Intelligent security association management server for mobile IP networks

(76) Inventor: Aki Yokote, San Francisco, CA (US)

Correspondence Address: BRINKS HOFER GILSON & LIONE, P.O. BOX 10395, CHICAGO, IL, 60610, US

(21) Appl. No.: 10/114,695

(22) Filed: Apr. 3, 2002

Related U.S. Application Data
(63) Continuation-in-part of application No. 09/827,632, filed on Apr. 6, 2001.

(51) Int. Cl. G06F 15/16

(52) U.S. Cl. 713/201; 709/223; 709/230

(57) ABSTRACT

A solution to asynchronous security association between nodes by implementing a security association policy server for IPsec in third generation and beyond wireless mobile access, Internet protocol-based digital networks supporting Mobile IP is disclosed. The security association policy server stores data related to a communication and a security association between nodes in the network, and determines an security association management protocol for the security association. Employing the security association management protocol for the particular security association, the security association management server determines an appropriate combination of security association management factors to ensure synchronization between nodes. The security association management server, may instruct a node to eliminate a security association stored in its cache when it is determined that the security association no longer needs to be stored, or may inform the nodes to re-key a security association when it is determined that the security association is not synchronized.

### CROSS-REFERENCE TO RELATED APPLICATIONS (35 U.S.C. § 120)

This application is a continuation-in-part application of co-pending U.S. patent application Ser. No. 09/827,632 filed on Apr. 6, 2001, and titled METHOD FOR IMPLEMENTING IP SECURITY IN MOBILE IP NETWORKS, by Aki Yokote (Attorney Docket No. 10745/6).

### INCORPORATION BY REFERENCE

The descriptive matter of co-pending U.S. application Ser. No. 09/827,632 filed on Apr. 6, 2001, and titled METHOD FOR IMPLEMENTING IP SECURITY IN MOBILE IP NETWORKS, by Aki Yokote (Attorney Docket No. 10745/6) is incorporated by reference in its entirety, and is made part of this application.

### BACKGROUND OF THE INVENTION

1. Field of Invention

The invention relates generally to Internet Protocol Security (IPsec) implemented in a wireless, mobile Internet protocol-based network, and more particularly, to synchronizing a Security Association (SA) for real-time interactive digital data communications, such as voice over IP (VoIP), in third generation and beyond wireless, mobile-access, Internet protocol-based data networks and wireless LANs.

2. Statement of Related Art

Digital data networks have become a ubiquitous part of business, commerce, and personal life throughout the United States and the world. The public Internet and private local and wide area networks (LANs and WANs) have become increasingly important backbones of data communication and transmission. E-mail, file access and sharing, and data-services access and sharing, are but a few of the many data communication services and applications provided by such networks.

Nearly all digital data networks including the Internet adhere to substantially the same addressing and routing protocols. According to these protocols, each of the network access devices (nodes) and servers (routers) in the network has a unique address, called the IP address. To communicate digital data over the network or between networks, a sender or source node subdivides the data to be transmitted into “packets.” A packet includes communication control data, such as the IP addresses of the source node and the intended destination node, and other information specified by the protocol, and substantive data to be passed on to the destination node. A single communication of data may require multiple packets to be created and transmitted depending on the amount of data being communicated and other factors. The source node transmits each packet separately, and the packets are routed via intermediary routers in the network from the source node to the destination node. The packets do not necessarily travel to the destination node via the same route, nor do they necessarily arrive at the same time. This is accounted for by providing each packet with a sequence indicator as part of the packetizing process. The sequence indicators permit the destination node to reconstruct the packets in their original order even if they arrive in a different order and at different times, thus allowing the original data to be reconstructed from the packets.

The International Telecommunication Union (ITU) of the Internet Society, the recognized authority for worldwide data network standards, has published its International Mobile Telecommunications-2000 (IMT-2000) standards. These standards propose so-called third generation (3G) and beyond (i.e., 3.5G, 4G etc.) data networks that include extensive mobile access by wireless, mobile nodes, including cellular phones, personal digital assistants (PDAs), handheld computers, and the like. The proposed third generation and beyond networks support IP based data communication (i.e., all data is communicated in digital form in packets via Internet addressing and routing protocols from end to end). Also, in the proposed third generation and beyond wireless networks, mobile nodes are free to move within the network while remaining connected to the network and engaging in data communications with other stationary or mobile network nodes. Among other things, such networks therefore provide facilities for addressing of moving mobile nodes, dynamic rerouting of data packets between the communicating nodes, as well as handling security and authentication issues when mobile nodes change network connections and packet routes.

It is particularly important for networks to provide adequate mobility support to mobile nodes because mobile nodes are expected to account for a majority or at least a substantial fraction of the population of the Internet in the near future. The Internet Engineering Task Force (IETF), an international community of network designers, operators, vendors, and researchers concerned with the evolution of the Internet architecture and the smooth operation of the Internet, have proposed several standards for mobility support. (See http://www.ietf.org). These include proposed standards for IP Mobility Support such as IETF RFC 2002, also referred to as Mobile IP Version 4 (IPv4), and draft working document “draft-ietf-mobileip-ipv6-13”, entitled “Mobility Support in IPv6,” also referred to as Mobile IP Version 6, both of which are incorporated herein by reference. According to the protocol operations defined in Mobile IPv4 and IPv6, a mobile node is allowed to move from one link to another without changing the mobile node's IP address. A mobile node is always addressable by its “home address,” an IP address assigned to the mobile node within its home subnet prefix on its home link. Packets are routed to the mobile node using this address regardless of the mobile node's current point of attachment to the Internet, and the mobile node may continue to communicate with a correspondent node (stationary or mobile) after moving to a new link. The movement of a mobile node away from its home link is thus transparent to transport and higher-layer protocols and applications.

Mobile IPv6 shares many features with Mobile IPv4, but the protocol is fully integrated into IP and provides many improvements over Mobile IPv4. For instance, support for “Route Optimization” is built in as a fundamental part of the protocol in Mobile IPv6, rather than being added on as an optional set of extensions that may not be supported by all nodes as in Mobile IPv4. The Route Optimization functionality optimizes the routing of packets by establishing a direct route between mobile and correspondent nodes. As discussed above, each mobile node is always identified by its home address, regardless of its current point of attachment to the Internet. While situated away from its home, a mobile node is also associated with a care-of address, which provides information about its current point of attachment to the Internet. In Mobile IPv4, a mobile node operating away from home registers its care-of address with its home agent. Likewise, in Mobile IPv6, a mobile node away from home sends a registration request to its home agent in order to notify the home agent of its current care-of address. The home agent that has received a registration request then intercepts packets destined for the mobile node and tunnels the packets to the mobile node's care-of address. In the reverse direction, however, packets are sent from the mobile node directly to its correspondent node. Thus, so-called triangle routing of packets occurs, which gives rise to the well-known asymmetrical packet latency problems. To establish a direct forwarding route from the corresponding node to the mobile node, the corresponding node is notified of the mobile node's current care-of address. In Mobile IPv4, the direct forwarding route may be established through the home agent sending binding information to an IPv4 mobile node when receiving from the corresponding node a packet destined to the mobile node away from home. In Mobile IPv6, establishment of direct routing is initiated by the mobile mode sending a binding update directly to the corresponding node.

Mobile IP also presents security issues. For instance, the registration protocol prescribed in Mobile IPv4 results in a mobile node's traffic being tunneled to its care-of address. This tunneling feature could however be a significant vulnerability if the registration was not authenticated between the home agent and the mobile agent. Also, the binding update operations standardized in Mobile IPv6 result in packets routed directly to a mobile node. This ability to change the routing of packets could raise a security concern if any packet containing a binding update was not authenticated between the mobile and correspondent nodes. These and other security issues associated with implementing mobile IP have long been recognized.

The fundamentals of IPsec architecture are set forth in IETF RFC 2401, entitled “Security Architecture for the Internet Protocol,” which is incorporated herein by reference. RFC 2401 proposes cryptographically-based IPsec consisting of a set of security services offered to address the issues of, for instance, connection integrity, data origin authentication, and confidentiality. Basically, the IPsec proposed in RFC 2401 relies upon a shared cryptographic key, with which communications between sender and receiver are encrypted and decrypted. Thus, for the IPsec proposed in RFC 2401 to work, sender and receiver must, before any communication to be protected takes place, establish agreements between them regarding a cryptographic key, an authentication or encryption algorithm, and a set of parameters needed to implement the algorithm. This set of agreements is called a security association (SA). Common methods for establishing a cryptographic key are key transport and key generation. An example of key transport is the use of a shared encryption key supplied from a trusted-third party authentication service. One of the most commonly used key generation methods is the Diffie-Hellman (D-H) algorithm. In the D-H algorithm, each of the sender and receiver mathematically combines the other's public information along with their own secret information to compute a shared encryption value. Details of the key management protocols, are set forth in RFC 2408, entitled “Internet Security Association and Key Management Protocol,” which is incorporated therein by reference.

IPsec is applicable in both Mobile IPv4 and Mobile IPv6 environments. For instance, during a registration process in Mobile IPv4 in which a mobile node situated away from home is registering its care-of address with its home agent, the home agent and the mobile node negotiate for a mutually agreeable SA and establish an encryption key that is to be used to protect subsequent communications being tunneled between them. Similarly, the above IPsec is implemented in the Route Optimization operations according to Mobile IPv6. A mobile node situated away from home sends a binding update to a correspondent node to notify the mobile node's current point of attachment to the Internet. The mobile and correspondent nodes then negotiate for a mutually agreeable SA and determine a cryptographic key that is to be used to protect subsequent communications routed directly between them. Ipsec provides for the creation of more than one SA having different security policies, between two nodes. The SA's are uniquely identified by a Security Parameter Index (SPI), which for example may be a 32 bit integer.

The above-proposed IPsec architecture works relatively well in mobile IP environments, yet efforts have been made to improve and better implement the proposed IPsec. For instance, the implementation of the proposed IPsec in mobile IP environments introduces certain time considerations into the process of establishing a SA between the mobile and correspondent nodes. To protect data transfer, an SA should be established before communication of secured data between nodes is established. However, time used for establishing the SA manifests itself as a delay. Once the SA is established, each node stores the SA in a cache, or Security Association Database (SAD). The SA therefore does not need to be re-established for future communications between these two nodes. However, due to security considerations, the SA has a discrete lifetime and is eliminated at its expiration.

Because each node has a limited storage capacity, only a discrete number of SA's can be stored by the node. In a typical example, a mobile node may communicate with a mail server, web sites, and its home agent. For each communication, two SA's are created—one for input of data and one for output of data. If each SA needs 256 bits of information, then the mobile node will need 1536 bits of data simply for these three SA's. When the number of SA's stored by a nodes has reached it limitations, and new communication is to be established, one of the stored SA's will need to be deleted to make room for with the new SA for the new communication. Typically, the SA's are eliminated according to an SA management protocol, such as eliminating a least recently used (LRU) SA. Because the SA at one of the nodes is eliminated, while the respective SA at the corresponding node is still stored, the SA is no longer synchronized. A new SA must be re-established when these nodes next communicate. Having to create a new SA, manifests delays for the future communications as well as inefficient use of memory. Accordingly, once an SA is created, the SA should not be eliminated, unless the SA lifetime has expired or a node requests for the SA to be deleted because, for example, the SA has been deemed compromised.

To optimize communications between nodes in the mobile network, it is desired to maintain the synchronization of the SA between two nodes. Use of keep-alive negotiation between nodes may be useful to synchronize SA between two nodes. In keep-alive negotiation, the nodes periodically exchange packets of information to determine whether the corresponding node is reachable. It is also possible to determine whether an SA is missing from the cache by exchanging packets of information including a SPI list. When an SA is deemed to have been missing, the respective SA at the corresponding node can be eliminated. However, these negotiations needs may introduce delays.

Communication delays may not be of large concern for e-mail transmissions and file transfers, because such data communications are not real-time interactive applications, and therefore are not particularly sensitive to communication delay. However, the real-time interactive data communication applications, such as VoIP and real-time interactive multi-media, have presented introduced new concerns for the implementation of the IPsec in mobile IP environments. Unlike e-mail and file transfers, such real-time interactive data communication applications are highly sensitive to timing considerations. Communication delays due to establishment of an SA becomes more significant if the key establishment process employs the key generation method, such as the D-H algorithm, which requires heavy computational overhead. To avoid delays in maintenance of the SA, it is desirable to ensure storage of the SA for its lifetime, and eliminate the SA only at the expiration of the lifetime of the SA. Synchronizing the SA's would result ensure that the SA's are properly maintained. Therefore, there is a need for an efficient management of the SA's for a mobile node to minimize delays in communications in a mobile network.

### SUMMARY OF THE INVENTION

Therefore, the purpose of the present invention is to provide an intelligent management method for synchronizing a security association (SA) between two nodes in a mobile network. Ensuring synchronous SA's between nodes reduces packet latency introduced by redundant authentication and SA establishment processes. Synchronization of SA between nodes also ensures efficient memory usage for the storage of multiple SA's at a node.

In one embodiment, an intelligent SA management server is established in the mobile network to provide synchronization of SA between nodes. The SA management server is configured to communicate with the nodes in the network and to store information associated with the communications between nodes. The SA management server is particularly configured to communicate with mobile nodes in an internet protocol network and store information associated with communications between those mobile nodes and the various other nodes in the network with which the mobile node has established communications. The information that the SA management server stores and maintains for a particular communication include a destination address for the communication, a source address for the communication, a kind of protocol used between the two nodes when communicating, a port number used between the two nodes, and the security policy for each SA.

The SA management server analyzes the communication information to determine an SA management protocol. The SA management protocol relates to a confidence level for maintaining the SA at the node. Based on the SA management protocol, the SA management server applies a variety of SA management factors, or predetermined criteria, to determine whether an SA is synchronized with the SA stored at the corresponding node. The SA management server determines, according to the SA management factors, whether the SA is synchronized and determines whether the SA should be eliminated prior to expiration of its lifetime, when it is determined that the SA is no longer synchronized. Depending on the SA management protocol, the SA management server may apply a variety of SA management factors to ensure the level of integrity desired for the SA.

A method for synchronizing a security association for a node in an internet protocol network includes storing a security association at a mobile node; storing data related to that security association at a SA management server; and, analyzing the data related to the security association, with the SA management server, according to a predetermined criteria to synchronize an SA. In analyzing the data the SA management server determines whether the security association stored at the mobile node is to remain for future communications or whether it should be eliminated prior to expiration of the lifetime of the SA. According to the method the mobile node communicates with the SA management server to provide data related to its communications with other nodes to the SA management server stores that analyzes that data to determine whether the SA stored at the node is synchronized with the SA stored at the corresponding node.

The intelligent SA manager reduces memory overhead and computational overhead of less resourceful nodes, such as mobile nodes, including PDAs and cellular phones. The SA management server is configured to determine for a node, which SA's should remain in storage for that node, and which may be eliminated from storage at that node. By managing the SA's for a node, the SA management server reduces packet latency introduced by authentication and security association establishment processes for SA's which may have been needlessly eliminated from storage in lieu of SA's that are less necessary to remain in storage and increases efficiency in the memory usage for storing SA's.

### BRIEF DESCRIPTION OF THE DRAWINGS

FIG. 1 is a graphical representation of a third generation wireless, mobile access, IP network in which the present invention is intended to operate;

FIG. 2 is a simplified graphical representation showing macro mobility of mobile node in a third generation wireless, mobile access, IP network with Mobile IP;

FIG. 3 is a simplified graphical representation showing macro mobility of mobile node and resulting Route Optimization in a third generation wireless, mobile access, IP network with Mobile IP;

FIG. 4 is a flowchart showing processes of implementing IPsec; and

FIG. 5 is a simplified graphical representation of a mobile IP network implementing an intelligent security association manager for synchronizing security associations for nodes.

### DETAILED DESCRIPTION OF THE PREFERRED EMBODIMENTS

The presently preferred embodiments of the invention are described herein with reference to the drawings, wherein like components are identified with the same references. The descriptions of the preferred embodiments contained herein are intended to be exemplary in nature and are not intended to limit the scope of the invention.

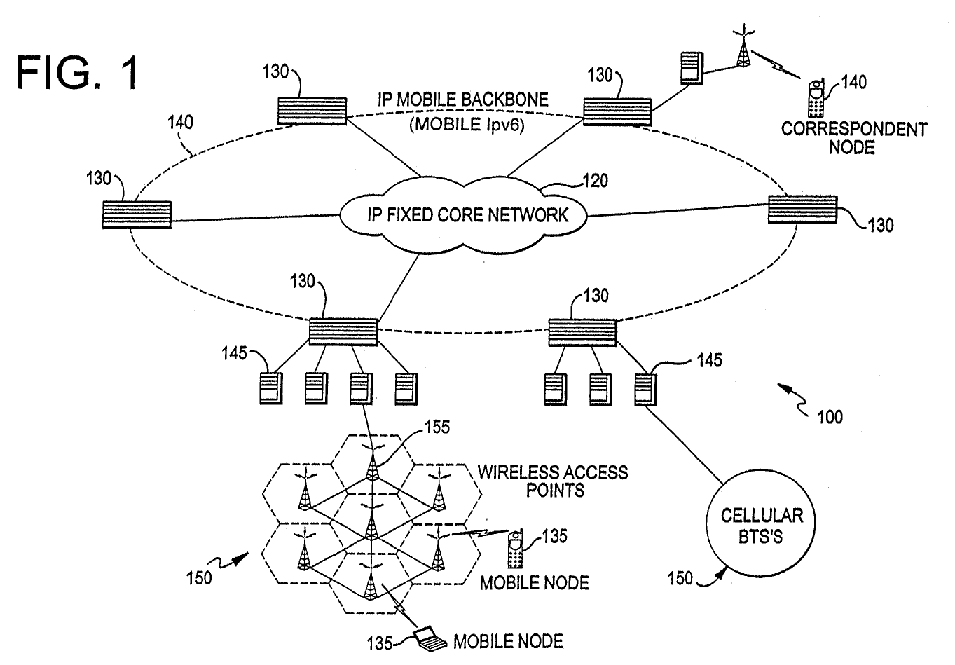

FIG. 1 illustrates graphically an example of a third generation, wireless, mobile access, IP data network 100 in which the invention is intended to find application. For purposes of the present description, it is assumed the network 100 adheres to the IMT-2000 standards and specifications of the ITU for wireless, mobile access networks. Additionally, it is assumed the network 100 implements Mobile IP support according to the proposed Mobile IPv6 and IPv4 standards of the IETF. These standards and specifications, as published on the web sites of ITU and IETF, have been incorporated herein by reference.

The wireless, mobile access, network 100 has as its core a fixed node IP data network 120 comprising numerous fixed nodes (not shown), i.e., fixed points of connection or links. Digital data is communicated within and over the network in accordance with Internet Protocols such as Internet Protocol Version 6 (Ipv6). Built on the core network 120 is a collection of gate routers 130 which collectively form an IP mobile backbone 140 and function, in accordance with the conventional Internet addressing and routing protocols, to route packets of data between source and destination nodes connected to the network. The gate routers 130 forming the IP mobile backbone 140 are themselves nodes of the core network 120 and have unique IP addresses for communication over the core network 120. Connected to each of the gate routers 130 are servers or routers 145. The routers 145 also have unique IP addresses and function as home agents (HA) and foreign agents (FA). The routers 145 interface mobile nodes (MN) 135 and correspondent nodes (CN) 140 to the core network 120, as specified in IETF RFC 2002 (“Mobile IP Version 4”), which has been incorporated herein by reference. The mobile nodes (MN) 135 and correspondent nodes (CN) 140 may be different kinds of mobile, wireless communication devices including cellular handsets, personal digital assistants (PDA's), hand-held computers, personal information managers, cellular telephones, wireless data terminals, and the like.

Each of the mobile nodes (MN) 135 and correspondent nodes (CN) 140 is assigned a home network (HN). Each node 135, 140 also has a home agent (HA), which is one of the routers 145 on the corresponding home network. For each of the nodes 135, 140, the home agent (HA) is the point of communication to the network 120 when the nodes 135, 140 are operating in its home network area. The mobile node's home agent 145 functions to route data packets to and from the mobile node (MN) 135 when it is operating in its home network area. According to the proposed Mobile IP support standards, the mobile node's home agent (HA) 145 also functions to maintain information related to the location of the mobile node 135 (i.e., the mobile node's care-of address, when it is operating away from its home network area). At least in the proposed base Mobile IPv4 standard, the home agent (HA) 145 also continues to participate in routing, or tunneling, packets to the mobile node (MN) 135 when it is at a foreign location outside of the home network.

Other routers 145 function as foreign agents (FA). Foreign agents (FA) provide network access points for the mobile node 135 when it is operating away from its home network area. The foreign agent (FA) via which a mobile node is connected to the network also functions to route packets to and from the mobile node 135, when the mobile node is outside of its home network.

Each agent, or router 145, has a base transceiver station (BTS) network 150 by way of which the mobile nodes 135, 140 communicate with their agents 145. Each of the base transceiver station (BTS) networks 150 includes multiple individual base transceiver stations (BTS's) 155. The mobile nodes 135, 140 and the BTS's employ known CDMA, W-CDMA or similar digital data communication technology to communicate with each other. The construction, arrangement, and functionality of the BTS networks 150 or BTS's 155 are conventional and standard. Similarly, the implementation of CDMA, W-CDMA or similar digital data communication technology in wireless, mobile node devices 135 and BTS's 155 is standard and known in the art.

Each node 135, 140 sends and receives packets of information according to the open system interconnection (OSI) standard. The OSI standard defines a framework for implementing protocols for communications in seven discrete layers, i.e., Application Layer (Layer 7), Presentation Layer (Layer 6), Session Layer (Layer 5), Transport Layer (Layer 4), Network Layer (Layer 3), Data Link (MAC) Layer (Layer 2), and Physical Layer (Layer 1). According to the OSI standard, control is passed from one layer to the next, starting at the top layer (Layer 7) in the source node and proceeding down to Layer I therein, and over the network to the destination node where the control climbs up the layers from the bottom to the top.

Among the layers, the bottom three layers include basic communication protocols. For instance, Layer 1 is responsible for passing bits onto and receiving bits from a BTS 150. This layer does not contain information related to the meaning of the data being transferred, but deals with the electrical and mechanical characteristics of the signals and signaling methods. Layer 2 is responsible for validity and integrity of communications with a BTS 150. This layer has some understanding of the meaning of the bits and deals with the communication protocols with a BTS 150. Layer 3 is responsible for establishing communication routes in networks 100 and includes information related to the meaning of data and deals with addressing, routing and security protocols.

Within the overall data network 100, three levels of mobile node mobility are contemplated: 1) Macro-mobility; 2) Intermediate mobility; and, 3) Micro-mobility. Macro-mobility refers to a change in location of a mobile node such that it leaves its home network (HN) and enters a network served by another agent, or foreign agent (FA). In other words, the mobile node's link or connection to the data network changes from one agent to another. Macro-mobility encompasses changes between a home agent (HA) and foreign agent (FA) or between foreign agents (FA), and is also called inter-agent mobility. Intermediate mobility refers to a change in location of a mobile node wherein its link to the network changes from one BTS network to another. Finally, micro-mobility refers to a change in location of a mobile node within a BTS network 150, in which case the mobile node's network link does not change.

The handling of intermediate mobility and micro-mobility are well known in wireless, cellular communication networks. For example, it is well known to use beacon signal strength for detecting and handling communication hand-offs between BTS's 150 when a mobile node device 135 changes location on a micro-mobility scale. Similarly, the detection and handling of communication hand-offs between BTS networks 150 when a mobile node 135 changes location across BTS network boundaries is standard and known in the art.

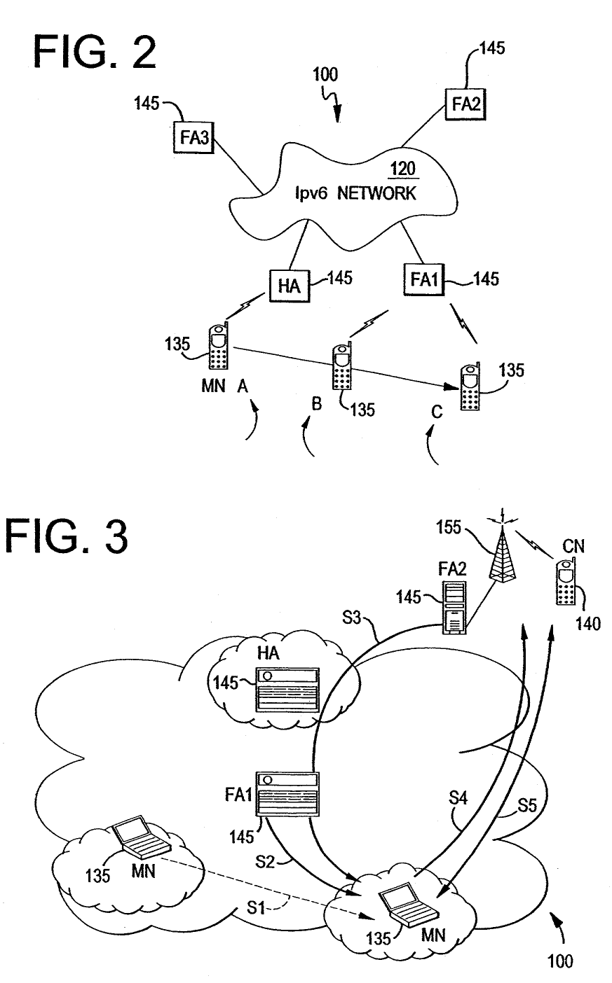

In FIG. 2, the network 100 includes the IPv6 network 120 and routers, or agents 145 connected to the IPv6 network 120. A hand-off process begins with a mobile node (MN) 135 at a location A and moving within the network to locations B and C. In the example illustrated, the MN 135 at location A is operating within its home link and connected to the network 120 via a home agent (HA) 145. The MN 135 preferably communicates with HA 145, wirelessly using CDMA, W-CDMA or similar wireless broadband spread-spectrum signal technology, for example, via BTS's, which are not shown in this example.

Both Mobile IPv6 and IPv4 standards provide mobility detection and hand-off functionality. In both versions, mobility of the MN 135 is detected via a Neighbor Discovery mechanism and results in a hand-off of the mobile node's network connection from a first agent to a second agent when the mobile node travels away from the area served by the first agent and enters the area served by the second agent. Thus, while the example illustrated is described with respect to a Mobile IP version 6 network, similar functionality and considerations exist for Mobile IP version 4 networks.

As the MN 135 moves from location A to intermediary location B, its movement is detected by an IP movement detection methodology or any combination of the methodologies available to it. The primary movement detection methodology for Mobile IPv6 uses the facilities of IPv6 Neighbor Discovery methodology including Router Discovery and Neighbor Unreachability Detection. The Neighbor Discovery is described in detail in IETF RFC 2461 entitled “Neighbor Discovery for IP Version 6 (IPv6), which is incorporated herein by reference, and which is recommended for Mobile IPv6 mobile nodes in the IETF Mobile IP Version 6 draft document previously identified and incorporated by reference.

While traveling from location A to location C through location B, the MN uses Router Discovery to discover new agents and on-link subnet prefixes. The Router Discovery operations include broadcasting of a Router Solicitation message by the MN 135. If the first foreign agent (FA1) 145 is situated sufficiently close to the MN 135 to be able to receive the Router Solicitation message, it will respond directly to the MN 135 with a Router Advertisement message. Alternatively, the MN 135 may simply wait to receive an unsolicited (periodic) Router Advertisement message from the FA1 145. When the MN 135 receives a Router Advertisement message from FA1 145, the MN 135 maintains an entry of the FA1 145 on its Default Router List and the FA1's subnet prefix on its Prefix List. Thus, the Default Router List identifies the FA1 145 as a candidate default agent with which the MN 135 may establish a new network connection.

While the MN 135 is leaving the HA 145, it is important for the MN 135 to be able to quickly detect when the HA becomes unreachable, so that it can switch to a new agent and to a new care-of address. To detect when its default agent becomes unreachable, the MN 135 uses Neighbor Unreachability Detection. In FIG. 2, at some point as the MN 135 reaches intermediary location B and continues toward location C, its network connection via the HA 145 begins to degrade. The degrading of the communication manifests itself as weakening of the L2 beacon signal and an increase in communication error detected by the MAC layer (Layer 2). Whether it is still reachable or not from the HA 145 is determined based on: (1) the loss of TCP acknowledgments in response from the HA 145 to packets if the MN 135 is in communication with the HA 145; and/or (2) the loss of unsolicited multicast Router Advertisement messages from the HA 145; and/or (3) receipt of no Neighbor Advertisement message from the HA 145 in response to an explicit Neighbor Solicitation messages to it.

If the MN 135 detects that its communication with the HA 145 begins to degrade, it has to begin hand-off operations and finish them before it completely loses the HA 145. The MN 135 first looks up its Default Router List and finds the FA1.

The MN 135 then establishes a communication link with the FA1 and closes the communication link with the HA 145. The communication hand-off between the HA 145 and FA1 145 requires the MN 135 to establish a new “care-of” IP address identifying its new foreign agent FA1 145. Preferred procedures for address autoconfiguration are specified in IETF RFC 2462 entitled “IPv6 Stateless Address Autoconfiguration,” which is incorporated herein by reference. According to the procedures, the mobile node's new care-of address is formed from the FA1's subnet prefix on the Prefix List that was advertised by the FA1. After these hand-off operations, by the time the MN 135 reaches its new location C, its network link has been established through the foreign agent FA1.

FIG. 3 graphically summarizes the steps taken for the registration of the new care-of address and Route Optimization after the above hand-off operations are completed. In Step 1 (S1), the MN 135 hands-off its network communication from the HA 145 to the foreign agent (FA1) 145. The MN 135 configures itself with the care-of address formed on the FA1's subnet prefix sent from the FA1 (Step 2) and sends a binding update to the HA 145 via FA1. Upon receipt of the binding update, the HA 145 registers the care-of address in its binding cache for the MN 135, thereby creating an association of the MN's home address with its current care-of address. The association in the binding cache has a lifetime and lapses after a predetermined time has passed.

Suppose that after the MN 135 hands-off its network connection to the FA1, a correspondent node (CN) 140 begins communication with the MN 135. Suppose further that the CN 140 has never communicated with the MN 135 and has no information about the MN's current location except its permanent home address. Thus, the CN 140 sends a first packet to the MN's home network (Step 3). The HA 145 intercepts the first packet from the CN 140 and looks up its binding cache for the MN's current care-of address. The HA 145 then encapsulates the first packet in another packet and tunnels it to the MN 135 at the MN's current care-of address via the FA1 145.

A proposed extension to the Mobile IP version 4 standard, specified in “draft-ietf-mobileip-optim-09.txt,” and published at “www.ietf.org/internet-drafts” can optimize packet routing by permitting establishment of a direct communication path between the MN 135 and the CN 140, thus bypassing the HA 145. The essence of this proposed extension has been integrated into the proposed Mobile IPv6 standards as discussed previously. Upon reception of the encapsulated packet tunneled from the HA 145, the MN 135 realizes that the CN 140 has no binding information associating the home address of MN 135 with the current care-of address of MN 135. In Step 4, the MN 135 sends a binding update to the CN 140. When receiving the binding update, the CN 140 maintains an entry of the MN's care-of address in its binding cache in association with the MN's permanent home address. Any packets destined for the MN 135 from the CN 140 will thereafter be routed directly to the MN 135 from the CN 140 (Step 5). Route Optimization thus eliminates the packet-latency problem that would occur from triangular routing.

During the above binding process, authentication and security association (SA) are performed between each node, such as between the MN 135 and the CN 140 and between MN 135 and FA1 145. The SA ensures that the communication with MN 135 is in fact legitimate and seeks avoid problems like eavesdropping, active replay attacks, and other types of attacks and unauthorized access to confidential data. Especially, the route optimization functionality could present serious security issues if the MN 135 sending a binding update was not properly authenticated at the CN 140, or a proper SA was not established between the MN 135 and the CN 140 for subsequent communications between them. IPsec provides a set of security services including authentication and confidentiality (encryption). IPsec is implemented through the use of two traffic security protocols, the Authentication Header (AH) and the Encapsulating Security Payload (ESP), and through the use of cryptographic key management procedures and protocols. The AH and ESP play an important role in implementing IPsec and are described in detail in RFC 2402 entitled “IP Authentication Header” and RFC 2406 entitled “IP Encapsulating Security Payload”, both of which are incorporated herein by reference. Detailed discussions on cryptographic key management procedures and protocols are found in RFC 2408 entitled “Internet Security Association and Key Management Protocol (ISAKMP), which has already been incorporated therein by reference.

Among various security procedures and protocols, a security association (SA) is fundamental to implementation of IPsec. An SA is a relationship between two nodes that describes security services that the nodes agree to use in order to communicate securely between them. Prior to the exchange of information between nodes, the nodes negotiate and establish a the SA between the nodes. Each node, then stores that SA, for a discrete lifetime of the SA.

The SA is uniquely identified by three factors consisting of a Security Parameter Index (SPI), an IP Destination Address and a security protocol (AH or ESP) identifier. The SPI is an identifier of a security protocol. The IP Destination Address indicates a home address or care-of address of the node at the other end of the communication. A node carries one SA for each of the nodes with which it is communicating or has communicated. Each SA has its own lifetime and expires after a predetermined time has passed. A SA is established between nodes before the nodes start exchanging packets that include data to be protected.

The establishment of a SA is important part of the key management protocol in cryptographically-based IPsec. The basic idea behind the cryptographically-based IPsec is that two nodes share a secret session key for use in encrypting and decrypting communications between the two nodes. Accordingly, the establishment of SA necessarily includes the establishment of a shared secret session key. There are two methods for key establishment. One method is called key transport in which a trusted third party, a key distribution center (KDC), holds secret session keys for all nodes within its network domain and distributes a secret session key to nodes wanting to begin a communication between them.

The other method for key establishment is termed key generation. An example of key generation uses of the Diffie-Hellman (D-H) algorithms to generate the secret session key. The D-H algorithm with the exchange of public information between the two nodes. Each node mathematically combines the other's information along with its own secret information to compute a shared secret value. This secret value can be used as a session key or as a key encryption key for encrypting a randomly generated session key.

It will be apparent to those skilled in the art that user authentication and establishment of SA could take a substantial period of time to perform, resulting in increased packet latency. Communication costs are calculated based on a number of packets transmitted versus the number of packets lost in the transmission. The present invention addresses the packet latency problem introduced by SA's which are not synchronized. Generally, the present invention provides a method that provides management of the SA for a MN 135 to decrease packet latency due to an SA between two nodes not being synchronized.

When a communication between nodes is first initiated, it is desirable to first establish an SA to ensure security in the exchange of data packets exchange between the nodes. When the nodes have had a prior communication an SA has been established and stored in the cache for each node. That stored SA can be re-used for future communications and avoid delays manifested in establishing the SA, thereby reducing latency in the communication between the nodes.

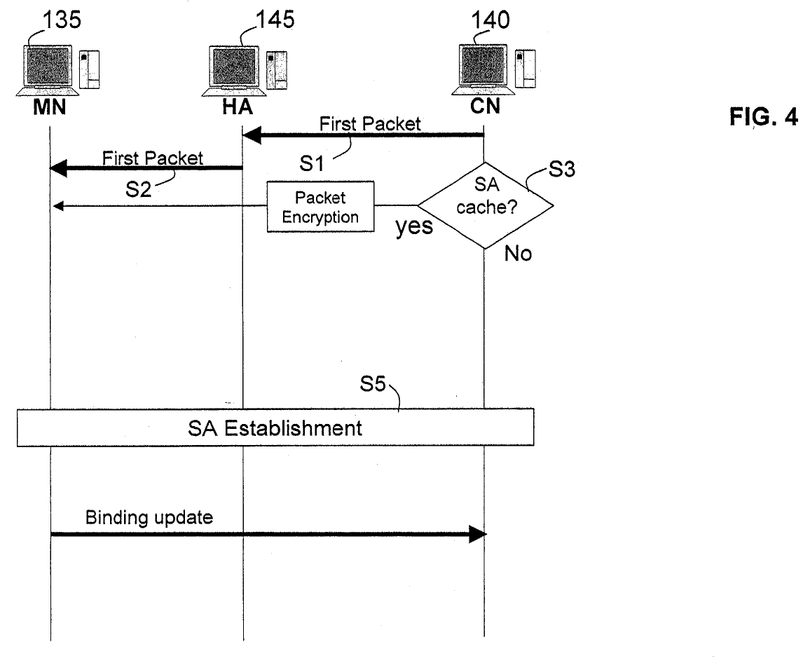

FIG. 4 illustrates a flow chart showing a method, including the steps for establishing a SA between nodes. The underlying data communication network used in these figures is the same as the one illustrated in FIG. 3, i.e., a third generation and beyond wireless, mobile-access, Internet protocol-based data network or a wireless LAN. Thus, the network used in these figures complies with the IPv4 and IPv6standards and supports both Mobile IPv4 and IPv6. The network also complies with the IMT-2000 standards and allows mobile access by wireless using CDMA, W-CDMA or similar wireless broadband spread-spectrum signal technology. In this particular embodiment shown in the figures, the network deals with real-time interactive multimedia data communications such as VoIP.

In FIG. 4, the CN 140 desires to establish a communication with the MN 135. Suppose that the binding cache in the CN 140 has not yet updated to reflect the current care-of address of MN 135. To begin the communication with the MN 135, the CN 140 sends a first packet for the MN to its home network (Step 1). This first packet is a control packet, the content of which varies depending on an application needed to implement and is just a request for connection in VoIP, for example. Since the first packet usually does not contain any data to be protected, it may be sent without any IPsec protection. The first packet is intercepted by the HA and then tunneled from the HA to the MN (Step 2). Depending upon an application being implemented in the CN 140, however, the first packet may not be a control packet, but a packet that contains data to be protected by IPsec before sent to the MN 135. If so, the Step 1 and Step 2 will be skipped directly to Step 3 to establish a security association (SA) between the CN 140 and the MN 135.

In step S3, the CN 140 looks up its security association (SA) cache to see if there is any SA established for communication with the MN 135. The SA cache may have multiple SA entries for a variety of communications. Each SA entry corresponds to a node with which the CN 140 is currently communicating or has communicated in the past. An SA is identified by several parameters including a Security Parameter Index, a Security Protocol Identifier and an IP destination address. In addition to these parameters, a SA has two parameters: one called an “IP destination home address,” and the other, called a “first packet flag.” The IP destination home address stores the home address of the node at the other end of the communication. The first packet flag is turned on when a first packet is sent to a node with which no SA is established and turned off when a SA is established with the node. The SA has a discrete lifetime and expires after a certain time has passed. When the lifetime expires, the SA entry is erased from the SA cache.

If an SA entry for the MN 135 is found in the SA cache, the CN 140 encrypts any subsequent packets with a session key identified by a Security Parameter Index (SPI) stored with the SA entry and sends them to the MN 135. If the CN 140 has not had a communication with the MN 135, there is no SA entry for the MN 135 in its cache. If the CN 140 has had a prior communication with the MN 135, there is a likelihood that the SA may have expired and there will be no SA entry for the MN 135. Likewise, if the SA has expired a new SA with the MN 135 will need to be established prior to transmission of data packets. If there is no SA entry for the MN 135 in the cache, the CN 140 moves to Step 5 and a new SA is to be established to with the MN 135. In Step 5, the CN 140 initiates establishment of an SA for the communication with MN 135.

If the CN 140 has had a prior communication with the MN 135, within the lifetime of the SA, both nodes should have entries for the SA stored at the respective nodes. However, the MN 135 may have eliminated the SA, due to, for example, a limited storage capacity for the SA's stored at the MN 135. In this case, the SA entry for at MN 135 is not present, yet the corresponding SA entry at the CN 140 is present, and the SA is not synchronized between the MN 135 and the CN 140. By way of example, when the CN 140 determines that there is an entry in the SA cache, yet the MN 135 does not recognize the encrytpted packet from CN 140, the MN 135 will initiate the establishment of the SA between the nodes. In this case, the SA is not synchronized and upon receipt of the first packet from the CN 140, the MN 135 realizes that an SA has not been established. The MN 135 sends a binding update to the CN 140 to have the CN 140 update its binding cache and an SA is established after the CN 140 receives the binding update from the MN 135. Thus, the MN 135 initiates SA establishment by sending a binding update to the CN 140. Because the SA is re-created, there may be packet latency in the communication. In addition, a new SA will need to be stored by CN 140, while the previous SA has yet to be eliminated.

The SA's have limited lifetimes and may be reused over the lifetime for multiple communications between the corresponding nodes. Since the SA's have long lifetimes, a node may have to curry a large number of SA entries. When a node eliminates an SA, prior to the expiration of the SA, while the corresponding node keeps the SA, the SA between the two nodes are not synchronized, and packet latency can occur during the establishment of an SA for a future communication between the nodes. There are several scenarios in which an SA may not be synchronized. For example, MN's 135 typically do not have a sufficient memory space to carry a large number of SA entries. When the SA cache at the MN 135 has reached its capacity limitation, the MN 135 may determine to eliminate one of the SA's in the cache to make room for the new SA. In one method, the MN 135 determines to eliminate the SA based on a least recently used (LRU) protocol. In particular, it is determined that the SA that has been least recently used is eliminated from storage. In another example, an SA between nodes may occur when the nodes are communicating and a node determines to eliminate its SA, without notifying the corresponding node. The corresponding node may store the SA until expiration of the lifetime of the SA. To address these problems, an intelligent SA manager server for synchronizing the SA's between nodes connected to the network is implemented.

It is desirable to maintain synchronization of SA's for the lifetime of the SA's. Therefore, when an SA becomes unsynchronized, it is desirable to detect the missing SA and resynchronize so that future communications can rely on the SA. It is also desirable to detect when an SA is no longer necessary so as to delete the SA. For example, the SA may have expired, the security of the SA may have been compromised, or one node may have sent a deletion notification. Finally, it is desirable to determine whether a re-key process should be executed.

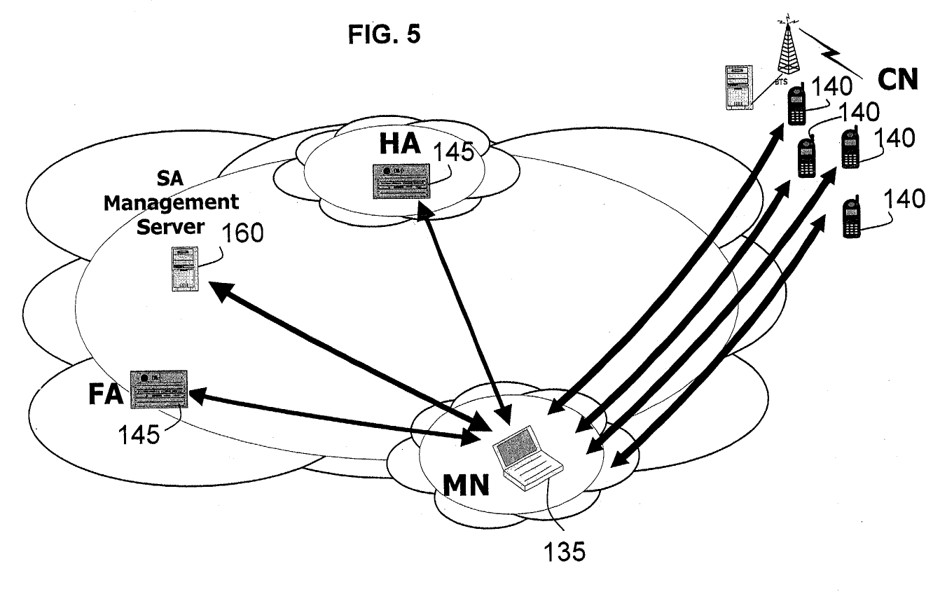

Referring to FIG. 5, an embodiment illustrating a network having an intelligent SA management server 160 is shown. The MN 135 may have established communications with various CN's 140, a HA 145 and a FA 145. For each such communication, the MN 135 has established and stores a discrete SA. However, because its storage capacity of a MN 135 may be limited, it is desirable to manage the storage of the SA in the cache for the MN 135 using the SA management server 160 to ensure the synchronization of the SA's for the MN 135. The SA management server 160 is in communication with the MN 135 and is configured to manage the SA for the MN 135 according to a SA management protocol. The SA management server 160, may also serve as a SA manager for other nodes in the network, such as other MN's 135 or CN's 140.

The SA management server 160 stores and maintains information related to a particular communication for the node as well as information related to the SA established for the communication. The information that the SA management server 160 may store includes a source address for the communication, the destination address for the communication, a kind of protocol established for the communication, a port number used for the communication, and a security policy that is negotiated between the nodes for the communication. The SA management server 160 may also store information related to the node, such as the size of the cache. Analyzing this information, the SA management server 160 determines a SA management protocol appropriate for the SA stored at the nodes to ensure an appropriate level of synchronization of the SA.

Using the SA management protocol, the SA management server 160 determines whether an SA stored at a node, such as MN 135, is to remain in the cache, or whether the SA is to be eliminated. When the SA management server 160 determines to eliminate the SA at the node, the SA management server 160 instructs the node to eliminate the SA. The SA management server may also detect that an SA is not synchronized and instruct the node to re-key the SA with the corresponding node. In this manner, the SA management server 160, maintains the SA entries in the cache at for nodes in the network to ensure synchronization of the SA's stored at the nodes.

The SA management protocol determines the level of protection that is to be provided for a particular SA. For example, based on the communication information, the SA management server 160 may determine that the SA management protocol necessary for particular SA is a high level, well protected SA; a medium level SA, or a low level SA. An SA requiring a high level of protection, for example, may be the SA established between the MN 135 and the HA 145, because it is used more frequently than others, while a low level security management protocol may be established for rarely used communications or low security communications. Thus, the SA management server 160 determines a level of integrity for the SA and provides for a higher-level synchronization over lower priority SA's. Therefore, the SA management server 160, determines a level of protection according the SA management protocol for the SA and based on the level of protection for the SA. When the SA management server 160 determines that an SA stored in the cache for the MN 135, the SA management server 160 communicates with the MN 135 to instruct the MN 135 to eliminate the SA from its cache. Likewise, when the cache for the MN 135 reaches a limitation, such as 70 percent of its capacity, the MN 135 may communicate with the SA management server 160 to determine which of the SA's should be deleted.

Depending on the SA management protocol determined for a particular SA, the SA management server 160 may employ a combination of a variety of known SA security methods, or SA management factors, to ensure the integrity of the SA at a node. Based on the SA management protocol, the SA management server determines which methods are appropriate for the maintaining the SA. The management factors include: maintaining SA's based on priority of the SA's; maintaining protection of the cache for a MN based on overflow principles; employing a keep-alive negotiation to ensure reachability of other nodes for which SA's are being stored; employing delete notification with a keep-alive negotiation, to eliminate SA for which there is no match found; and employing a re-key process for a lost SA.

In employing a priority based SA management factor, the SA management server determines which SA's may be eliminated based on the priorities of the various SA's stored at the particular node. High priority SA's may will be eliminated only after lower priority SA's. An example of a high-level SA includes an VoIP communication, whereas a low priority may include an SA for an e-mail communication. One method for priority based SA management is to eliminate the SA's based on a least recently used (LRU) principle. In the LRU principle, the SA that has been used the least recent is eliminated. This principle, however, may result in a high-priority SA being eliminated. Accordingly, the SA management server 160, employs other SA management factors to ensure the integrity of high priority SA's

Another example of an SA management factor includes, use of keep-alive negotiation between the nodes. Employing this factor, the SA management server 160 instructs the nodes to periodically exchange packets of information to determine whether the other node is reachable. If the node is determined to be unreachable, the SA management server 160 may determine that the SA is unnecessary and instruct the node to eliminate the SA from its cache. In addition, the SA management server 160 may instruct the nodes to send a deletion notification to when a node is determined unreachable, so that the SA's remain synchronized. The SA management server 160 may also instruct the use of exchanging SPI lists with the keep-alive negotiation. When the SPI lists are exchanged, the nodes can detect missing SA's and determine whether to delete the missing SA, or to re-establish the SA. Because of communication costs associated with keep-alive negotiation, the SA management server may reserve such keep-alive negotiation for high-priority SA's in combination with other SA management factors.

Another SA management factor that the SA management server 160 may use to synchronize the SA's is to employ a re-key process for a particular SA. When the SA management server 160 has determined that an SA has been lost, it may instruct the nodes to initiate a re-key for their SA. However, the re-key process may introduce problems with overflow at the nodes, so the SA management server 160, determines whether the re-key process is desirable based on other SA management factors and the SA management protocol for the SA.

Depending on the level of integrity that the SA management server 160 determines for a particular SA, the SA management server 160 determines which combination of SA management factors to employ to ensure a the confidence level for the SA. By way of example, for high-level SA's, the SA management server 160 may determine to employ all SA management factors to synchronize the SA, while for low-level SA's the SA management server may employ only a priority based SA management factor to ensure the synchronization of the SA.

What have been described are preferred embodiments of the present invention. The foregoing description is intended to be exemplary and not limiting in nature. Persons skilled in the art will appreciate that various modifications and additions may be made while retaining the novel and advantageous characteristics of the invention and without departing from its spirit. Accordingly, the scope of the invention is defined solely by the appended claims as properly interpreted.

What is claimed is:

1. A method of implementing internet protocol security in a mobile IP network, comprising the steps of:
a. establishing a security association for a communication between a first node and a second node;
b. storing, at the first node and at the second node, the security association; and
c. synchronizing, with a security association policy server, the security association between the first node and the second node.

2. A method as recited in claim 1, wherein step (c) comprises:
a. establishing a communication between the first node and the security association policy server;
b. storing, at the security association policy server, information associated with the communication between the first node and the second node, including a first node address, a second node address, a kind of protocol for the communication, a port number for the communication, and a security policy for the security association;
c. selecting a security association management protocol based on the information associated with the communication between the first node and the second node;
d. determining whether the security association stored at the first node is to be deleted according to the security association management protocol; and
e. informing the first node to delete the security association when it is determined that the security association is not synchronized.

3. A method as recited in claim 2, wherein the step of establishing a security association management protocol comprises:
a. determining whether to delete the first security association stored at the first node according to priority of use of the first security association;
b. determining whether to delete the first security association stored at the first node based on an overflow protection policy of a first node security association database;
c. determining whether to delete the first security association stored at the first node based on keep-alive negotiation protocol;
d. determining whether to delete the first security association stored at the first node based a deletion notification with a keep-alive negotiation protocol; and
e. determining whether to delete the first security association stored at the first node based on re-key process protocol.

4. A method as recited in claim 1, wherein the first node is a mobile node.

5. A method as recited in claim 1, wherein the security association expires at the termination of a lifetime and is used over multiple sessions of communications between the first node and the second node.

6. A method as recited in claim 1, wherein the communication is a real-time interactive digital data communication.

7. A method as recited in claim 1, wherein the real-time interactive digital data communication is voice over Internet protocol.

8. A method as recited in claim 1, wherein the network complies with International Mobile Telecommunications-2000 standards.

9. An internet protocol network comprising:
a. a plurality of nodes configured to communicate with each other over the network, and to store security associations for communications the between plurality of nodes;
b. at least one security association policy server provided in the network and in communication with the nodes, the at least one security association policy server configured to synchronize the security associations between the nodes according to a security association management protocol.

10. An internet protocol network as recited in claim 9, wherein the at least one security association policy server is configured to store information related to a communication between nodes, the information comprising:
a. a source address;
b. a destination address;
c. a kind of protocol;
d. a port number; and
e. a security policy for the communication.

11. An Internet protocol network as recited in claim 10, wherein the security association policy server establishes the security association management protocol based on the information related to a communication between nodes.

12. An internet protocol network as recited in claim 11, wherein the at least one security association policy server determines whether to a security association stored at a node is to be eliminated from storage, according to the security association protocol and a combination of security association management factors.

13. An internet protocol network as recited in claim 12, wherein the combination of security association management factors comprise:
a. priority of security associations stored at a node;
b. security association database overflow;
c. keep-alive negotiation;
d. deletion notification during keep-alive negotiation; and
e. re-key process.

14. An internet protocol network as recited in claim 9, wherein the communication is a real-time interactive digital data communication.

15. An internet protocol network as recited in claim 9, wherein the real-time interactive digital data communication is voice over Internet protocol.

16. An internet protocol network as recited in claim 9, wherein the network complies with International Mobile Telecommunications-2000 standards.

17. A method for synchronizing a security association for a node in an internet protocol network, comprising the steps of:
a. storing a security association at a mobile node for a communication between the mobile node and a second node in the network, the mobile node storing the security association for no more than a discrete lifetime;
b. storing at a security association policy server, data related to the security association stored at the mobile node; and
c. analyzing the data related to the security association according to a predetermined criteria to determine a whether the security association stored at the mobile node is eliminated prior to expiration of the lifetime.
